(19) United States
(12) Patent Application Publication
(10) Pub. No.: US 2022/0388596 A1
(43) Pub. Date: Dec. 8, 2022

(54) Front Wheel Guide for a Single-Track Motor Vehicle

(71) Applicant: Bayerische Motoren Werke Aktiengesellschaft, Muenchen (DE)

(72) Inventor: Christian GLUECK, Obertraubling (DE)

(21) Appl. No.: 17/774,928

(22) PCT Filed: Sep. 28, 2020
(86) PCT No.: PCT/EP2020/077040

§ 371 Date: May 6, 2022

(30) Foreign Application Priority Data
Nov. 8, 2019 (DE) 10 2019 130 169.6

(51) Int. Cl. B62K 25/08; B62K 21/04; F16C 11/06

(52) U.S. Cl. CPC B62K 25/08; B62K 21/04; F16C 11/06

(57) ABSTRACT

A front wheel guide for a single-track motor vehicle has a telescopic fork, a fork bridge and a longitudinal control arm. The telescopic fork has two fork rods, which each have a lower fork tube and an upper fork tube which can be slid relative to the lower fork tube. The fork bridge extends in a transverse direction and interconnects the lower fork tubes of the fork rods. The longitudinal control arm, which is pivotably articulated to the vehicle, is connected to the fork bridge by way of a ball joint. The front wheel guide is characterized in that the longitudinal control arm is rotatably mounted on the ball joint by way of at least one rolling element bearing.

### BACKGROUND AND SUMMARY OF THE INVENTION

The invention relates to a front wheel guide for a single-track motor vehicle with a telescopic fork, a fork bridge and a longitudinal link.

A ball joint is installed on the lower fork bridge in order to ensure the kinematic clearances of a Telelever front wheel guide for a single-track motor vehicle. In the case of steering movements, this ball joint has to rotate about a ball pivot axis. The following conflict of objectives arises in the process. As low a frictional torque as possible about the steering axis is required, in order to achieve an accurate ride feeling in the low speed range. In contrast, as high a rigidity as possible in the ball joint is necessary, in order to achieve the required ride stability in the high speed range. The rigidity of the ball joint can be influenced by way of the geometry and the prestress of the parts and the joint. A high prestress in the joint leads to a high rigidity and a higher frictional torque about the joint axis.

It is therefore an object of the present invention to provide a front wheel guide for a single-track motor vehicle, which front wheel guide is optimized with regard to the conflict of objectives between a low frictional torque and a high rigidity.

This object is achieved by way of the combination of features according to the independent claim.

According to the invention, a front wheel guide for a single-track motor vehicle with a telescopic fork, a fork bridge and a longitudinal link is proposed. The telescopic fork comprises two fork rods which in each case comprise a lower fork tube and an upper fork tube which is arranged displaceably relative thereto. The fork bridge extends in a transverse direction, that is to say transversely with respect to an axis from the front wheel to the rear wheel, and in the process connects the lower fork tubes of the fork rods to one another. The longitudinal link which is articulated pivotably on the motorcycle is connected by means of a ball joint to the fork bridge. Moreover, the longitudinal link is mounted rotatably on the ball joint by means of at least one anti-friction bearing.

In this way, the frictional torque about the ball joint is minimized by way of an additional anti-friction bearing. Therefore, a defined frictional torque about the steering axis can be achieved independently of the ball joint. This leads to a considerable improvement in the accuracy in the low speed range. Furthermore, the rigidity requirements can be defined independently of the frictional torque about the ball joint. For this reason, the ride stability in the high speed range can be optimized without influencing the frictional torque about the steering axis. Furthermore, a longer service life of the ball joints can be achieved, since a longer service life until replacement on account of play in the ball joint is made possible by way of higher rigidity in the ball joint.

It is provided in one advantageous design variant that the longitudinal link is mounted rotatably on the ball joint by means of two anti-friction bearings. The mounting of the longitudinal link about the ball joint is optimized on account of the two anti-friction bearings. The two anti-friction bearings are arranged next to one another and rotate about a common rotational axis. This mounting improves and simplifies the adaptation of the frictional torque about the steering axis and the fixing on the ball joint.

The ball joint preferably comprises a ball joint pivot which extends along a ball pivot axis. Here, the respective anti-friction bearing mounts the longitudinal link on the ball joint pivot rotatably about the ball pivot axis. It is favorable here that the ball joint pivot is adapted to the requirements of rotatable mounting of the longitudinal link, with the result that the frictional torque about the steering axis is optimized further.

It is provided in one exemplary embodiment of the invention that the ball joint pivot comprises two radially extending projections which in each case form a shoulder for contact of the respective anti-friction bearing and between which the anti-friction bearing or bearings is or are arranged or fixed in a positively locking manner. On account of the shoulder, the degree of freedom of the anti-friction bearing in relation to an axial positional change with regard to the ball pivot axis is blocked in the direction of the shoulder.

Furthermore, one embodiment is favorable, in the case of which the longitudinal link comprises a fastening portion with an opening for engaging over the ball joint pivot. As a result, the longitudinal link can be mounted simply and securely on the ball joint or the anti-friction bearing or bearings. Furthermore, the longitudinal link is mounted on the anti-friction bearing or bearings by means of the opening.

According to the invention, it is provided in a further advantageous variant that the opening of the longitudinal link comprises an engagement ring which is arranged between the two anti-friction bearings. It is an advantage of this that the anti-friction bearings bear against the engagement ring and this therefore blocks a further degree of freedom in relation to an axial positional change with regard to the ball pivot axis.

The front wheel guide according to the invention is configured in one design variant such that the respective anti-friction bearing is fixed in a positively locking manner between in each case one projection and the engagement ring. It is favorable here that the respective anti-friction bearing bears against the engagement ring and, in this way, fixes the corresponding anti-friction bearing in a positively locking manner by way of the corresponding projection or the corresponding shoulder.

Furthermore, it is provided in one alternative embodiment of the present invention that the engagement ring of the longitudinal link is arranged spaced apart from the ball joint pivot, as a result of which a gap is configured. Therefore, the longitudinal link is mounted on the ball joint pivot indirectly by way of the anti-friction bearings and is not in contact with it. As a consequence, the frictional torque of the mounting is not influenced by way of the engagement ring.

In a further variant according to the invention, the anti-friction bearing is a spherical roller bearing or a tapered roller bearing. These two anti-friction bearing designs are particularly suitable in the case of the present application for mounting on account of their properties with regard to the rigidity and the frictional torque.

It is advantageous, furthermore, if a connecting region between the fork bridge and the ball joint is sealed with respect to a surrounding area by way of a seal. As a result, this mounting of the front wheel guide is sealed with respect to the surrounding area and, as a consequence, also with respect to contamination, as a result of which the service life of the front wheel guide and/or the mounting are/is extended.

A further aspect of the invention relates to a single-track motor vehicle, in particular a motorcycle with a front wheel suspension system according to the invention.

Other advantageous developments of the invention are characterized in the dependent claims or will be shown in greater detail in the following text together with the description of the preferred embodiment of the invention on the basis of the figures.

### BRIEF DESCRIPTION OF THE DRAWINGS

FIG. 1 is a perspective view of a front wheel guide for a single-track motor vehicle; and

FIG. 2 is a sectional view of a connecting region of a front wheel guide for a single-track motor vehicle.

### DETAILED DESCRIPTION OF THE DRAWINGS

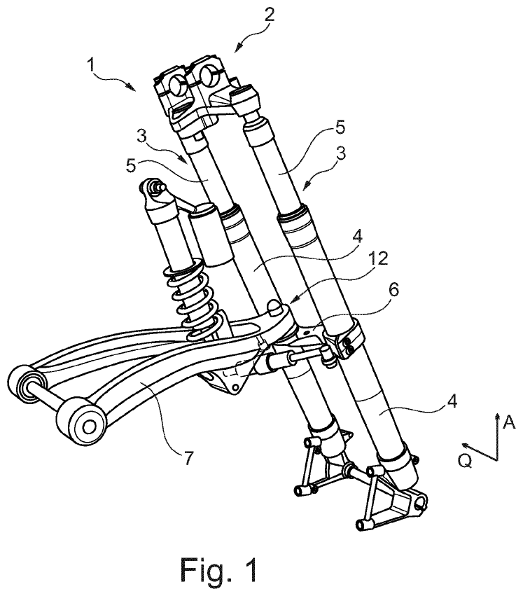

FIG. 1 shows a perspective view of a front wheel guide 1 for a single-track motor vehicle with a telescopic fork 2, a fork bridge 6 and a longitudinal link 7.

The telescopic fork 2 has two fork rods 3 which in each case comprise a lower fork tube 4 and an upper fork tube 5 which is arranged displaceably relative thereto. Here, the fork bridge 6 extends in the transverse direction Q, and connects the lower fork tubes 4 of the fork rods 3 to one another. The transverse direction Q runs transversely with respect to an axis which extends from the front wheel to the rear wheel of the single-track motor vehicle. Furthermore, the longitudinal link 7 which is articulated pivotably on the single-track motor vehicle (not shown) is connected to the fork bridge 6 in a connecting region 12.

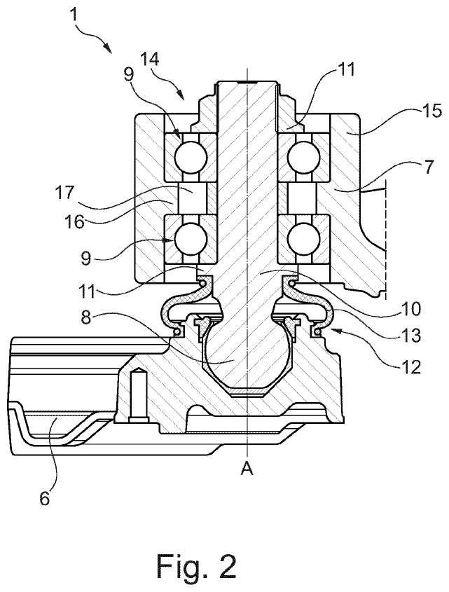

FIG. 2 shows a sectional view of the connecting region 12 which is shown in FIG. 1 between the fork bridge 6 and the longitudinal link 7 of the front wheel guide 1. The longitudinal link 7 which is articulated pivotably on the single-track motor vehicle (not shown) is connected to the fork bridge 6 by means of a ball joint 8. The fork bridge 6 has a receptacle with a shape of a truncated tetrahedron. This receptacle is adapted correspondingly to the spherical portion of the ball joint 8, with the result that the longitudinal link 7 is mounted on the fork bridge 6 in an optimum manner.

Furthermore, FIG. 2 shows that the longitudinal link 7 is mounted rotatably on the ball joint 8 by means of two anti-friction bearings 9. For this purpose, the ball joint 8 comprises a ball joint pivot 10 which extends along a ball pivot axis A. Here, moreover, the respective anti-friction bearing 9 mounts the longitudinal link 7 on the ball joint pivot 10 rotatably about the ball pivot axis A. In this design variant, the anti-friction bearing 9 is configured as a spherical roller bearing.

The ball joint pivot 10 comprises two radially extending projections 11 which are configured in each case as a shoulder for contact with the respective anti-friction bearing 9, and between which the two anti-friction bearings 9 are arranged or fixed in a positively locking manner.

The longitudinal link 7 configures a fastening portion 15 which comprises an opening 14 for engaging over the ball joint pivot 10. This opening 14 of the longitudinal link 7 comprises an engagement ring 16 which is arranged between in each case one outer ring of the two anti-friction bearings 9. A sleeve is situated between a respective inner ring of the two anti-friction bearings 9. In the sectional view of FIG. 2, the fastening portion 15 with the engagement ring 16 has a T-shaped structure, as a result of which a supporting face for the respective anti-friction bearing 9 is configured. As a consequence, the respective anti-friction bearing 9 is fixed in a positively locking manner between in each case one of the two projections 11 and the engagement ring 16 or the sleeve. Here, the anti-friction bearings 9 bear by way of their cages against the shoulder or the projection 11 and the engagement ring 16 or the sleeve.

Moreover, FIG. 2 shows that the engagement ring 16 of the longitudinal link 7 is arranged spaced apart from the ball joint pivot 10, as a result of which a gap 17 is configured. The connecting region 12 between the fork bridge 6 and the ball joint 8 is sealed with respect to a surrounding area by way of a seal 13.

1.-10. (canceled)

11. A front wheel guide for a single-track motor vehicle, comprising:
a telescopic fork comprising two fork rods which, in each case, comprise a lower fork tube and an upper fork tube which is arranged displaceably relative thereto;
a fork bridge extending in a transverse direction and connecting the lower fork tubes of the two fork rods to one another;
a longitudinal link which is articulated pivotably on the single-track motor vehicle, and is connected via a ball joint to the fork bridge; and
at least one anti-friction bearing by which the longitudinal link is mounted rotatably on the ball joint.

12. The front wheel guide according to claim 11, wherein
the longitudinal link is mounted rotatably on the ball joint via two anti-friction bearings.

13. The front wheel guide according to claim 11, wherein
the ball joint comprises a ball joint pivot which extends along a ball pivot axis, and
the respective anti-friction bearing mounts the longitudinal link on the ball joint pivot rotatably about the ball pivot axis.

14. The front wheel guide according to claim 13, wherein
the ball joint pivot comprises two radially extending projections which, in each case, form a shoulder for contact of the respective anti-friction bearing and between which the anti-friction bearing is arranged or fixed in a positively locking manner.

15. The front wheel guide according to claim 13, wherein
the longitudinal link comprises a fastening portion with an opening for engaging over the ball joint pivot.

16. The front wheel guide according to claim 12, wherein
the longitudinal link comprises a fastening portion with an opening for engaging over the ball joint pivot, and
the opening of the longitudinal link comprises an engagement ring which is arranged between the two anti-friction bearings.

17. The front wheel guide according to claim 16, wherein
the respective anti-friction bearing is fixed in a positively locking manner between, in each case, one projection and the engagement ring.

18. The front wheel guide according to claim 16, wherein
the engagement ring of the longitudinal link is arranged spaced apart from the ball joint pivot, as a result of which a gap is configured.

19. The front wheel guide according claim 11, wherein
the at least one of anti-friction bearing is a spherical roller bearing or a tapered roller bearing.

20. The front wheel guide according to claim 11, wherein
a connecting region between the fork bridge and the ball joint is sealed with respect to a surrounding area by way of a seal.
